(19) United States
(12) Patent Application Publication
(10) Pub. No.: US 2024/0347984 A1
(43) Pub. Date: Oct. 17, 2024

(54) SMART GUITAR CABLE

(71) Applicant: Sound Devices LLC, Reedsburg, WI (US)

(72) Inventor: Matthew G. Anderson, Madison, WI (US)

(73) Assignee: Sound Devices LLC, Reedsburg, WI (US)

(21) Appl. No.: 18/633,119

(22) Filed: Apr. 11, 2024

Related U.S. Application Data
(60) Provisional application No. 63/496,198, filed on Apr. 14, 2023.

(51) Int. Cl. H01R 13/66; G10H 3/18

(52) U.S. Cl. CPC H01R 13/6658; G10H 3/186

(57) ABSTRACT

Methods and devices are provided whereby deficiencies in the impedance of a cable connecting an electric guitar and a wireless transmitter or other audio device may be electronically corrected, according to user preferences. User settings may be saved and recalled as needed from a program interface that serially communicates with electronics controlling the behavior of the cable.

### CROSS-REFERENCE TO RELATED APPLICATION

The present application claims priority of U.S. Provisional Patent Application No. 63/496, 198, filed Apr. 14, 2023, the content of which is incorporated herein by reference in its entirety.

### FIELD OF THE INVENTION

The disclosed invention provides means to improve the flexibility and performance of corded electrical guitars such that a consistent sound quality can be achieved and maintained between different guitars and wiring configurations. In addition, RF interference can be minimized by providing a balanced signal connection between the guitar and microphone input.

### BACKGROUND OF THE INVENTION

Amplified musical instruments have been in use for the last several decades. The electrical output signal from a guitar, or from a pick up for another stringed musical instrument, is typically provided as the input to an audio mixer, or other electrical equipment designed to record, playback, or process the musical signal. In the particular case of an electric guitar, the electronic signals from the guitar chords may be locally amplified and transmitted to a wireless audio transmitter that digitizes the signal and provides this information wirelessly to other audio or musical devices. The advantage of such an approach is to remove the need for a longer cord attached to the guitar, as it is carried and used by a musician during a performance. Using a wireless transmitter may remove the concern for any clumsy interaction that could occur between an electric guitar cord and the musician, such as becoming entangled with the legs (or ankles or feet) of the musician, or even an accidental pulling of the guitar plug from the guitar resulting from a musician (or another band member) stepping on the cord while the guitar player is in motion (jumping or dancing) as part of a performance.

A rather straightforward approach involves mounting a high dynamic range body-pack transmitter on the guitar player mounted at a location on his or her body that has a minimal impact on their ability to play the instrument or move as needed, especially during a live performance. The audio content from the electric guitar may then be wirelessly transmitted to any other desired audio equipment, such as mixers, recorders, amplifiers or monitoring equipment for further processing, recording or playback.

Ideally, a corded connection between guitar and body-pack transmitter would not be so long as to droop down along the legs of the performer but should be set at a length only sufficient to provide the performer with the flexibility of movement they desire between themselves and the guitar. As such, optimal lengths for such a cord may range from a few feet to 6 feet at most. Typical electric guitar signals are amplified by a JFET based amplifier prior to transmission over the cord. Especially in cases where longer cords are employed, the internal capacitance of the cord can have a significant effect on the sound quality or tone of the guitar output as it is received by equipment downstream from the cable.

Commercial guitar cables typically vary in the range from 10 to 20 feet of length. Due to subtle differences (in the impedance) between differing cords, the resultant sound quality can vary perceptibly from using one cord to the next. For this reason, musicians after becoming accustomed to (and becoming familiar with) a particular cord, may set aside certain (preferred) cords for use in performances where they are concerned about any differences in the resultant sound quality based on the fact that they “know” and “trust” the presence of certain sound qualities associated with these cords.

### DESCRIPTION OF THE PRIOR ART

Changing the capacitance of a guitar cord for improved sound quality is a technique that has been contemplated in the prior art. For example, in U.S. Pat. No. 8,246,384 by Henry Wallace, a tunable guitar cord is disclosed whereby a user may manually control an electronic amplifier that affects the inter-electrode capacitance between conductors in the cord. It is worth noting that other relevant sources for related prior-art are also disclosed by the Wallace patent. However, manually tuning a guitar-cord pair presents the need for a musician (who is familiar with the process) to spend time optimizing the pair each time when either the guitar or cord is exchanged for another. The present invention overcomes these limitations by allowing a user (or musician) to save settings (for a guitar-cord pair) in a device and recall them at a later time-without the need to manually re-adjust either device.

### SUMMARY

The present invention relates generally to a system for creating music, wherein the system includes an electric guitar providing an unbalanced analog audio signal as is typical. The invention is also useful for other stinged musical instruments using an audio pick up, such as electric base, acoustic guitar pickup, or violin or piano pick ups. This audio output may be physically connected to an amplifier input or microphone input of a wireless transmitter. In this disclosure, the phrases “cord” and “cable” are used interchangeably with regard to providing a physical (wired) electrical connection between an electric guitar and amplifier input or wireless transmitter.

In a first aspect, the invention pertains to a musical producing system comprising a musical instrument having an audio pick up such as an electrical guitar, a smart guitar cord and a wireless transmitter that transmits an RF signal containing audio data to a wireless receiver. Based on the RF signal received (and decoded) by the receiver, further audio processing, recording or playback may be subsequently performed. In particular, the capacitance of a cable is typically measured as per unit length of the cable. For example, a common value is in the range of 50 to 80 pF/m. Generally speaking, a very long cord can produce what is often referred to as a “darkening” for the tone of the guitar, where higher pitched harmonics are somewhat attenuated. For this reason, musicians will often experimentally select a cable that they find agreeable with regards to desired sound quality. Most often, cord lengths in the range of 10 to 15 feet are considered desirable. To provide such a length of cable between a guitar and body-worn transmitter would be clumsy—whereas a generally shorter cable (2 to 6 feet) offers a comfortable level of “slack” in allowing the performer to maneuver their guitar into a comfortable holding position while performing. The problem here is that this shorter length of cord often provides insufficient capacitance for the desired sound quality. This is further complicated by the fact that different performers are likely to have differing preferences in regard to the optimal sound quality (in connection with optimal cord length).

In this first aspect of the invention, the guitar cable is configurable to optimize the sound quality for the electrical guitar as part of the system, regardless of how short it is, according to the preferences of a user.

In another aspect of the invention, the guitar cable provides a balanced output transmission to reduce the effects of electrical interference or noise that is superimposed on audio information as received at the input to the wireless transmitter.

Providing musicians with the means to adjust or select the capacitance of a guitar cord, resolves difficulties associated with a shorter guitar cord that is optimally designed for wearing comfort when placed between an electric guitar and body-worn wireless transmitter.

### BRIEF DESCRIPTION OF THE DRAWINGS

FIG. 1 shows a portion of a smart guitar cable according to an exemplary embodiment of the invention illustrating a ¼-inch plug (headphone jack) on the end of the cable that connects to the output from an electric guitar.

FIG. 2 shows another portion of the smart guitar cable according to the exemplary embodiment of the invention illustrating a locking 3-pin connector on the end of the cable that connects to the input port of a wireless transmitter.

FIG. 3 illustrates a functional block diagram describing how components within the smart guitar cable system are interconnected and operate according to the exemplary embodiment of the invention.

### DETAILED DESCRIPTION OF THE INVENTION

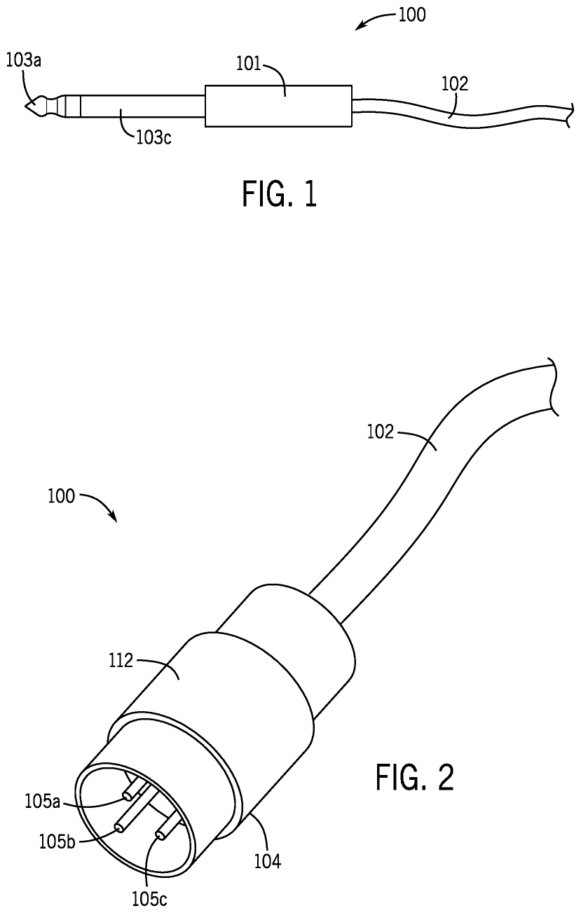

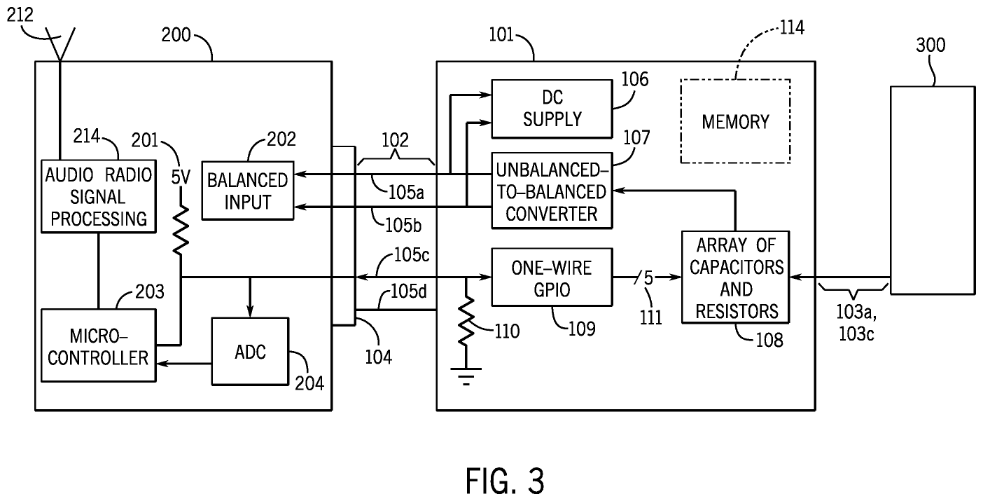

FIG. 1 shows the guitar end of a smart guitar cord 100 according to an exemplary embodiment of this invention. A male ¼-inch headphone plug is intended to be connected to a female audio output jack (guitar plug) that exists on most modern electric guitars. The plug includes a ¼ inch unbalanced connector contact 103a, and a ground contact 103c. This end of the cord is of special interest, since in this embodiment, the plug housing 101 provides sufficient internal volume to house all of the internal electronics required within the smart guitar cable 100. In alternative embodiments, these electronics can be contained in an appropriate enclosure placed anywhere along the length of the cord. In yet other embodiments, it may even become possible to enclose those electronics in a snap-on housing module that connects between the plug contacts 103a, 103c and the guitar 300 (FIG. 3), without departing from the scope of the invention. Still referring to FIG. 1, at the other end of the plug housing 101, a 4-conductor wire 102 extends for the needed length of the cord, terminating at a locking connector 104, as illustrated in FIG. 2 that is designed to mate with a wireless transmitter or other compatible audio device. A suitable locking connector 104 is a 3-pin push-pull connector manufactured under brand name LEMO®, by a Swiss Company named Lemo SA, and size to mate with the input port on the RF transmitter 200, 210 (FIG. 3). As can be seen from FIG. 2, the locking connector 104 includes a moveable sleeve (or collar) 112 that may be either push-pull or threaded such that it can securely lock (or screw on) to a mated receiver port 210 on the wireless RF transmitter 200. In this embodiment, three (male) pins 105a-c are shown. In a preferred embodiment, two 105a,b of these three pins carry a balance audio signal from the guitar, while the third pin 105c carries serial data communication signals, from the wireless RF transmitter 200 to electronics in the plug housing 101 on the end of the smart guitar cable 100 by the electric guitar 300. A DC power source may be superimposed on the conductors for the balanced output to provide electrical power to the smart guitar cable. The smart guitar cable 100 desirably includes a fourth conductor 105d as a shielding conductor to provide a grounding source.

FIG. 3 illustrates a system level (or “bird's eye”) view to facilitate understanding of the smart guitar cord connection and operation between an electric guitar 300 and wireless RF transmitter 200. The invention can be implemented for example using the commercially available A10-TX, A10-TX-US, A20-mini, or A20-TX wireless digital RF transmitters manufactured by the Assignee of this application. The wireless RF transmitter 200 has an RF antenna 212 that transmits digital audio data wirelessly at a selected radio frequency to an RF receiver. The digital audio signal is output from the microcontroller 203 and processed, as is known in the art, e.g. at least through a modulator and an RF amplifier, see reference number 214, prior to sending the signal to the RF antenna 212 for radio transmission.

A one-wire general purpose input/output port 109 is provided in the housing 101 of the smart guitar cable 100 to receive control or data signals over line 105c from the microcontroller 203 on the RF transmitter 200, and to also output signals from the smart guitar cable 100 to the microcontroller 203 on the wireless RF transmitter 200. The wireless RF transmitter 200 is likely battery powered and includes an internal DC power supply 201, e.g. 5 VDC, which is used to power the electronics within the RF transmitter 200 and also the smart guitar cable 100 if it is connected to the RF transmitter 200. An analog-to-digital converter (ADC) 204 in the RF transmitter 200 provides the voltage level on line 105c to the microcontroller 203, which enables the microcontroller 203 to determine when a smart guitar cable 100 is connected. In the event that a compatible smart guitar cable is attached, an ID resistor 110 creates a known voltage drop on conductor 105c that when reported by the ADC 204 to the microcontroller 203 signals whether a smart guitar cable 100 is attached. The wireless RF audio transmitter 200 uses a resistor circuit to detect the resistance of the ID resistor 110 when the smart guitar cord 100 is connected to the port on the wireless RF audio transmitter 200. Different models of the smart guitar cables 100 can be used to implement the invention and the specific model is desirably identified by unique values encoded in the ID resistor 110, which are detected after connection between the smart guitar cable 100 and wireless RF transmitter 200. Line 105d represents a shielded ground in the cable 102.

Once the microcontroller 203 recognizes that a smart guitar cable 100 has been attached, it desirably enables a dependent menu system (in addition to any other required control menus) for the user on an information display mounted in the wireless RF transmitter 200. Alternatively, control of the menu can occur from a user interface remote from the wireless transmitter 200, such as from a user interface for a receiver or mixer in the audio system, or from a smart phone or pc communicating directly or indirectly with the transmitter, or possibly directly to the GPIO 109 in the housing 101 of the smart guitar cable 100. From there, a user (or musician) may select various capacitance and resistance parameters and test the sound quality until the desired tone is achieved. The physical capacitance and resistance are configured by setting the capacitor and resistor array 108. These may be configured into the circuit with analog switches that are programmed on/off by messages received at a GPIO chip 109 and placed such that additional capacitor or resistor elements operate in series or parallel to default components, as needed to achieve the most desirable values. For example, capacitive values wired in parallel and resistive values wired (by selective activation of analog switches) in series are additive to each other. Reference number 111 refers to the selection of switches to turn on and off by the GPIO messages. An impedance converter is desirably included in the circuit with an input connected in common with the output of the configurable capacitor and resistor array 108.

Electronics in the housing 101 for the smart guitar cable may be powered by a DC supply 106, which is supplied power (e.g. 5 VDC) from the wireless transmitter 200 superimposed over the balanced inputs of the cable 102. An exemplary embodiment of the invention allows the user to save the settings to memory (or a library of settings), allowing them to be recalled at a later time. Desirably, the smart guitar cord 100 includes non-volatile memory 114 in the housing 101 capable of storing settings of the configurable array of capacitors and resistors even when disconnected from electrical power. This feature is particularly useful since the user can unplug the equipment and maintain the settings automatically upon setting up the equipment for the next session even if a different wireless RF transmitter 200 was used that did not have the capability to configure the smart guitar cable. Memory on other devices can be used to store additional settings or recommended settings as well. For example, the user may accumulate a labeled collection of settings corresponding to group of guitars models they possess, where upon connection, settings for a desired model may be accessed and programmed into the smart guitar cable automatically.

Other advantages of the disclosed invention include the use of a balanced, rather than unbalanced connection over the 4-conductor cable 102. This feature may function by converting the unbalanced signal received from the guitar 300 by the unbalanced-to-balanced converter 107 located in the plug housing 101 for the smart guitar cable. A suitable converter 107 can be made from op amps and resistors as is known in the art. Converting to a balanced signal before analog transmission over cable 102 greatly reduces the susceptibility of the system to external or self-generated electromagnetic waves or interference (that may cause a humming sound in the output of unbalanced systems).

Another advantage is that the 3-pin locking connector conforms to the industry standard for connection to unbalanced Lavalier microphones, while enabling the present invention to operate.

1. An electric guitar audio transmission system comprising:
an electric guitar providing an analog audio signal;
a smart guitar cord that has an input plug for receiving the analog audio signal from the electric guitar, an output plug for outputting a tonal-modified analog audio signal and for transmitting configuration data, and a housing containing a GPIO for receiving configuration data and a configurable array of capacitors and resistors to modify the tonal quality of the analog audio signal; and
a wireless RF audio transmitter having a port for receiving the output plug of the smart guitar cable and a microprocessor configured in part to transmit configuration data over the guitar cable to program the settings of the configurable array of capacitors and resistors to modify the tonal quality of the analog audio signal.

2. The electric guitar audio transmission system in claim 1 wherein the housing also contains non-volatile memory capable of storing settings of the configurable array of capacitors and resistors even when disconnected from electrical power.

3. The electric guitar audio transmission system in claim 1 wherein the output plug on the smart guitar cord is a 3-pin locking connector.

4. The electric guitar audio transmission system in claim 3 wherein the input plug on the smart guitar cord is a male unbalanced plug which receives an unbalanced analog audio signal from the guitar, and the housing contains an unbalanced-to-balanced signal converter, wherein the configurable array of capacitors and resistors in the housing modifies the tonal quality of the unbalanced, analog audio signal and outputs a tonal-modified, unbalanced analog audio signal which is converted by the unbalanced-to-balanced converter to generate a tonal-modified, balanced analog audio signal that is transmitted to the port of the wireless RF audio transmitter using two of the three pins in the 3-pin locking connector.

5. The electric guitar audio transmission system in claim 4 wherein the housing contains a DC power supply which receives DC power from the wireless RF audio transmitter over the two conductors in the smart guitar cable transmitting the tonal-modified, balanced analog audio signals by superimposing the DC power on the tonal-modified, balanced analog audio signals.

6. The electric guitar audio transmission system in claim 3 wherein the cable connected between the housing and the output plug on the smart guitar cord has four conductors with one of the conductors being a grounded shield.

7. The electric guitar audio transmission system in claim 1 wherein the housing of the smart guitar cord also contains an impedance converter in the circuit having an input connected in common with the output of the configurable array of capacitors and resistors.

8. The electric guitar audio transmission system in claim 1 wherein the GPIO also outputs data that is transmitted over the smart guitar cable to the port of the wireless RF audio transmitter.

9. The electric guitar audio transmission system in claim 2 wherein a user can reset configuration data stored in the non-volatile memory using a user interface on the wireless RF audio transmitter, or another user interface such as an app on a smart phone or PC that has access to the wireless RF audio transmitter or can otherwise communicate with the GPIO in the housing for smart guitar cable.

10. The electric guitar audio transmission system in claim 1 wherein the housing for the smart guitar cable includes an identifying resistor and the wireless RF audio transmitter includes means for detecting the identifying resistor when the smart guitar cord is connected to the port on the wireless RF audio transmitter.

11. The electric guitar audio transmission system in claim 1 wherein the configurable array of capacitors and resistors also includes analog switches which are opened and closed by the instructions from the microprocess through the GPIO to modify the tonal quality of the analog audio signal.

12. A musical instrument audio transmission system comprising:
an audio pickup for the musical instrument providing an analog audio signal;
a smart cable that has an input plug for receiving the analog audio signal from the audio pick up, an output plug for outputting a tonal-modified analog audio signal and for transmitting configuration data, and a housing containing a GPIO for receiving configuration data and a configurable array of capacitors and resistors to modify the tonal quality of the analog audio signal; and
a wireless RF audio transmitter having a port for receiving the output plug of the smart cable and a microprocessor configured in part to transmit configuration data over the smart cable to program the settings of the configurable array of capacitors and resistors to modify the tonal quality of the analog audio signal.

13. The musical instrument audio transmission system in claim 12 wherein the housing also contains non-volatile memory capable of storing settings of the configurable array of capacitors and resistors even when disconnected from electrical power.

14. The musical instrument audio transmission system in claim 12 wherein the output plug on the smart cable is a 3-pin locking connector.

15. The musical instrument audio transmission system in claim 14 wherein the input plug on the smart guitar cable is a male unbalanced plug which receives an unbalanced analog audio signal from the guitar or pick up, and the housing contains an unbalanced-to-balanced signal converter, wherein the configurable array of capacitors and resistors in the housing modifies the tonal quality of the unbalanced, analog audio signal and outputs a tonal-modified, unbalanced analog audio signal which is converted by the unbalanced-to-balanced converter to generate a tonal-modified, balanced analog audio signal that is transmitted to the port of the wireless RF audio transmitter using two of the three pins in the 3-pin locking connector.

16. The musical instrument audio transmission system in claim 15 wherein the housing contains a DC power supply which receives DC power from the wireless RF audio transmitter over the two conductors in the smart cable transmitting the tonal-modified, balanced analog audio signals by superimposing the DC power on the tonal-modified, balanced analog audio signals.

17. The musical instrument audio transmission system in claim 12 wherein the cable connected between the housing and the output plug on the smart cord has four conductors with one of the conductors being a grounded shield.

18. The musical instrument audio transmission system in claim 12 wherein the housing of the smart cord also contains an impedance converter in the circuit having an input connected in common with the output of the configurable array of capacitors and resistors.

19. The musical instrument audio transmission system in claim 12 wherein the GPIO also outputs data that is transmitted over the smart cable to the port of the wireless RF audio transmitter.

20. The musical instrument audio transmission system in claim 13 wherein a user can reset configuration data stored in the non-volatile memory using a user interface on the wireless RF audio transmitter, or another user interface such as an app on a smart phone or PC that has access to the wireless RF audio transmitter or can otherwise communicate with the GPIO in the housing for smart cable.

21. The musical instrument audio transmission system in claim 12 wherein the housing for the smart cable includes an identifying resistor and the wireless RF audio transmitter includes means for detecting the identifying resistor when the smart cord is connected to the port on the wireless RF audio transmitter.

22. The musical instrument audio transmission system in claim 12 wherein the configurable array of capacitors and resistors also includes analog switches which are opened and closed by the instructions from the microprocess through the GPIO to modify the tonal quality of the analog audio signal.

23. A smart cable comprising:
a cord comprising at least three conductors;
an ¼ inch male input plug for receiving unbalanced, analog audio signals from an electric guitar or a pick up;
an output plug comprising a 3-pin locking connector for outputting a tonal-modified, balanced analog audio signal and for transmitting configuration data, and
a housing containing:
a GPIO for receiving configuration data over one of the conductors in the cable and one of the pins in the 3-pin locking connector,
a configurable array of capacitors and resistors that modifies the tonal quality of the unbalanced, analog audio signal and outputs a tonal-modified, unbalanced analog audio signal, wherein the settings of the configurable array can be set or reset from configuration data received by the GPIO,
non-volatile memory capable of storing settings of the configurable array of capacitors and resistors even when disconnected from electrical power,
an unbalanced-to-balanced signal converter which converts the tonal-modified, unbalanced analog audio signal to generate a tonal-modified, balanced analog audio signal that is transmitted over two of the conductors of the cable and two of the three pins in the 3-pin locking connector.

24. The smart cable in claim 11 wherein the housing further contains a DC power supply which receives DC power over the two conductors in the smart cable transmitting the tonal-modified, balanced analog audio signals by superimposing the DC power on the tonal-modified, balanced analog audio signals.

25. The smart cable in claim 11 wherein the housing further contains an identifying resistor.

26. The smart cable in claim 11 wherein the housing further contains an impedance converter in the circuit after the configurable array of capacitors and resistors.

27. The smart cable in claim 11 wherein the GPIO is also capable outputting data over the smart cable.

28. The smart cable in claim 11 wherein the cable connected between the housing and the output plug has four conductors with one of the conductors being a shield.
